(19) United States
(12) Patent Application Publication
(10) Pub. No.: US 2014/0096075 A1
(43) Pub. Date: Apr. 3, 2014

(54) METHOD OF AND CIRCUIT FOR DISPLAYING IMAGES ASSOCIATED WITH A PLURALITY OF PICTURE FILES

(71) Applicant: John Joseph King, Wheaton, IL (US)

(72) Inventor: John Joseph King, Wheaton, IL (US)

(21) Appl. No.: 13/632,314

(22) Filed: Oct. 1, 2012

(51) Int. Cl. G06F 3/048

(52) U.S. Cl. 715/800; 715/781

(57) ABSTRACT

A method of displaying images associated with a plurality of picture files on a display of a portable wireless device is disclosed. The method comprises displaying a first image associated with a first picture file; enabling a user to identify a location associated with the first picture file; and displaying a second image in response to a prompt for a next picture file; wherein the second image is related to the first image.

### FIELD OF THE INVENTION

The present invention relates generally to portable wireless devices, and in particular, to a method of and circuit for displaying images associated with a plurality of picture files.

### BACKGROUND OF THE INVENTION

With the arrival of digital cameras which create digital images, photographers have not only been able to take more pictures cheaply, but have also been able to share the images more easily. Further, because the digital images do not have to be developed to be viewed, but can be viewed on any computing device which is capable of displaying a digital image, the digital images can be more widely distributed and used in used in a variety of ways. For example, digital images may be easily transferred to a portable wireless device from a portable memory device, such as a flash memory which may easily be coupled to a universal serial bus (USB) port of a portable wireless device. Alternatively, picture files may be easily downloaded to a portable wireless device by way of a wireless communication network or by a direct wired connection to a computer. While some digital images are personal, many digital images are commonly known or recognizable. Accordingly, digital images can have mass appeal, and therefore can be used in entertainment or gaming applications which may be of interest to many people.

### SUMMARY OF THE INVENTION

A method of displaying images associated with a plurality of picture files on a display of a portable wireless device is disclosed. The method comprises displaying a first image associated with a first picture file; enabling a user to identify a location associated with the first picture file; and displaying a second image in response to a prompt for a next picture file; wherein the second image is related to the first image.

According to an alternate embodiment, a method of displaying images associated with a plurality of picture files on a display of a portable wireless device comprises displaying a first image associated with first picture file; receiving a request for a hint by a user; and displaying a second image in response to the request for a hint; wherein the second image is related to the first image.

A portable wireless device enabling the display of an image is also disclosed. The portable wireless device comprises a memory storing a plurality of picture files; a control circuit coupled to the memory, the control circuit enabling the display of a first image associated with a first picture file of the plurality of picture files; and a display enabling a user to identify a location associated with the first picture file, wherein a second image is displayed in response to a prompt for a new image.

### BRIEF DESCRIPTION OF THE DRAWINGS

FIG. 1 is a top plan view of a portable wireless device according to an embodiment;

FIG. 2 is a block diagram of a portable wireless device according to aN embodiment;

FIG. 3 is a diagram showing data fields of a name for a picture file according to an embodiment;

FIG. 4 is a hint lookup table according to an embodiment;

FIG. 5 is an answer lookup table according to an embodiment;

FIG. 6 is an audio/visual lookup table according to an embodiment;

FIG. 7 is a top plan view of a portable wireless device showing a game selection mode for an individual player and available options and sub-options according to an embodiment;

FIG. 8 is a top plan view of a portable wireless device showing a game selection mode for single player and available options and sub-options according to an embodiment;

FIG. 9 is a top plan view of a portable wireless device showing a game selection mode for players in a multiplayer mode and available options and sub-options according to an embodiment;

FIG. 10 is a top plan view of a portable wireless device showing a location selection according to an embodiment of the present invention;

FIG. 11 is a top plan view of a portable wireless device showing sub-location selection according to the embodiment of FIG. 10;

FIG. 12 is a top plan view of a portable wireless device showing a category selection according to an embodiment;

FIG. 13 is a top plan view of a portable wireless device showing sub-category selection according to the embodiment of FIG. 12;

FIG. 14 is a top plan view of a portable wireless device showing a difficulty selection according to an embodiment;

FIG. 15 is a top plan view of a portable wireless device showing hint option and sub-option selections according to an embodiment;

FIG. 16 is a top plan view of a portable wireless device showing an interface enabling a multiple choice answer selection according to an embodiment;

FIG. 17 is a top plan view of a portable wireless device showing an interface enabling a keyboard answer entry according to an embodiment;

FIG. 18 is a top plan view of a portable wireless device showing a plurality of images associated with a particular location which may be identified by a multiple choice answer selection according to an embodiment;

FIG. 19 is a top plan view of a portable wireless device showing a plurality of images associated with a particular location which may be identified by a multiple choice answer selection according to an alternate embodiment;

FIG. 20 is a correct answer lookup table for an individual user according to an embodiment;

FIG. 21 is a block diagram of elements of a system enabling communication with the portable wireless device according to an embodiment;

FIG. 22 is a block diagram of a system having a monitor enabling gaming with two portable wireless devices according to an embodiment;

FIG. 23 is a block diagram of a wireless communication network enabling a plurality of portable wireless devices to display the same image according to an embodiment;

FIG. 24 is a block diagram of a wireless communication network having a remote computer communicating with a wireless communication device according to an embodiment;

FIG. 25 is a flow chart showing a method of storing data associated with picture files according to an embodiment;

FIG. 26 is a flow chart showing a method of enabling a game associated with picture files according to an embodiment;

FIG. 27 is a flow chart showing a method of enabling the downloading the picture files to a portable wireless device according to an embodiment; and

FIG. 28 is a flow chart showing the operation of a user interface of a portable wireless device according to an embodiment.

### DETAILED DESCRIPTION OF THE DRAWINGS

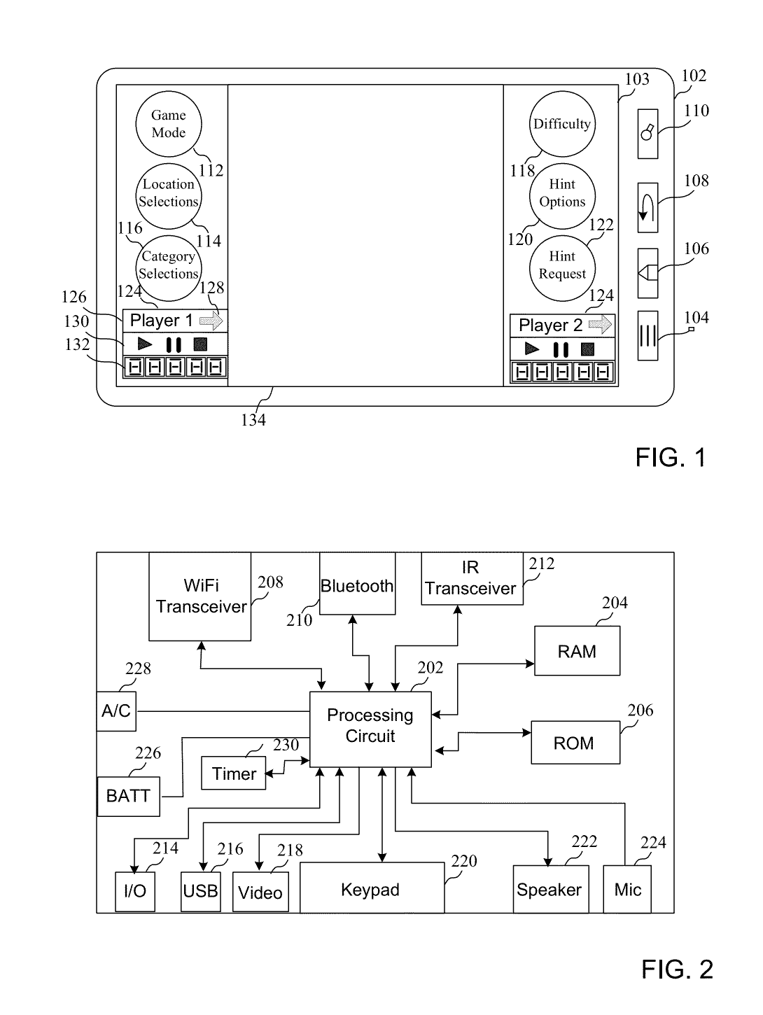

Turning first to FIG. 1, a top plan view of a portable wireless device according to an embodiment is shown. In particular, a portable wireless device 102 comprises a display 103 and a plurality of user interface actuators, including a menu actuator 104, a home screen actuator 106, a back actuator 108 and a search actuator 110. The user interface actuators enable a user to select certain menu options associated with a current program that is running on the portable wireless device, including a program for identifying the location of an image associated with a picture file as described in more detail below. The home screen actuator 106 enables a user to return to a home screen, which may include a variety of programs which can be selected by a user. The back actuator enables a user to return to a previous screen within a program, for example. The search actuator enables a user to search, via a touch screen keypad or in response to a voice entry, the portable wireless device or some other database accessible by the portable wireless device. While certain actuators are shown according to the embodiment of FIG. 1, it should be understood that other actuators, a greater number of actuators, fewer actuators, or a different combination of actuators could be employed. Further, while “mechanical” actuators are shown by way of example for the user interface actuators, the user interface actuators could be implemented as “touch screen” applicators, which will be described in more detail below in relation to the program for identifying a location of an image displayed on the device.

The display 103 is preferably a touch screen display, and enables the input of data or the selection of features associated with a game for identifying the location of an image. According to one embodiment, a game mode interface 112, a location selection interface 114, a category selection interface 116, a difficulty selection interface 118, a hint options interface 120, and a hint request interface 122 is shown. The operation of the various interfaces 112-122 will be described in more detail below. According to other embodiments, one or more player control panels are provided. As shown in FIG. 1, two player control panels 124 have a player designation 126, a selection option 128, a player control 130 having a play actuator, a pause actuator and a stop actuator, and a scoreboard 132. The selection option 128 may be used to “pass” and advance to a next picture file in a location identification game. As will be described in more detail, the portable wireless device could be a portable cellular telephone or tablet computer, such as a cellular telephone or tablet computer implementing an operating system from Apple, Inc, Google, Inc. or Microsoft Corporation, for example. Alternatively, the various programs and interfaces could be implemented on any type of display having an appropriate interface, such as a computer or a television having a corresponding wireless actuator.

Turning now to FIG. 2, a block diagram of circuit of the portable wireless device enabling the user interface of FIG. 1 according to a embodiment is shown. A processing circuit 202, which could be any type of microprocessor or other control circuit, for example, is coupled to a plurality of elements which enable the operation of the portable wireless device. In particular, a read only memory (ROM) 204 for storing program data, and a random access memory (RAM) 206 are accessable by the processing circuit 202. The portable wireless device also had a plurality of interfaces, including wireless interfaces, such as a WiFi transceiver 208, a Bluetooth transceiver 210, a infrared (IR) transceiver 212, for example. The portable wireless device may also include wired connections. For example, the portable wireless device may comprise a general purpose I/O 214, a universal serial bus (USB) 216, a video adapter 218, a keypad port 220 for coupling a keypad to the device, a speaker 222, and a microphone port 224. The portable wireless device preferably has a battery 226 for enabling the operation of the device without an A/C adapter, although A/C power for charging the battery or operating the device may be enabled by an alternating current (A/C) adapter port 228. Finally, a timer 230 may be implemented for maintaining various elapsed times, as will be described in more detail below. Alternatively, the timing functions could be provided by the processing circuit 202. As will be described in more detail below, the keypad could be a touchscreen keypad on the display, or could be a mechanical type keyboard integrally associated with the portable wireless device or attached to the portable wireless device. While various components are shown in FIG. 2, more or fewer components may be implemented as necessary to implement the methods of displaying an image as described in more detail below.

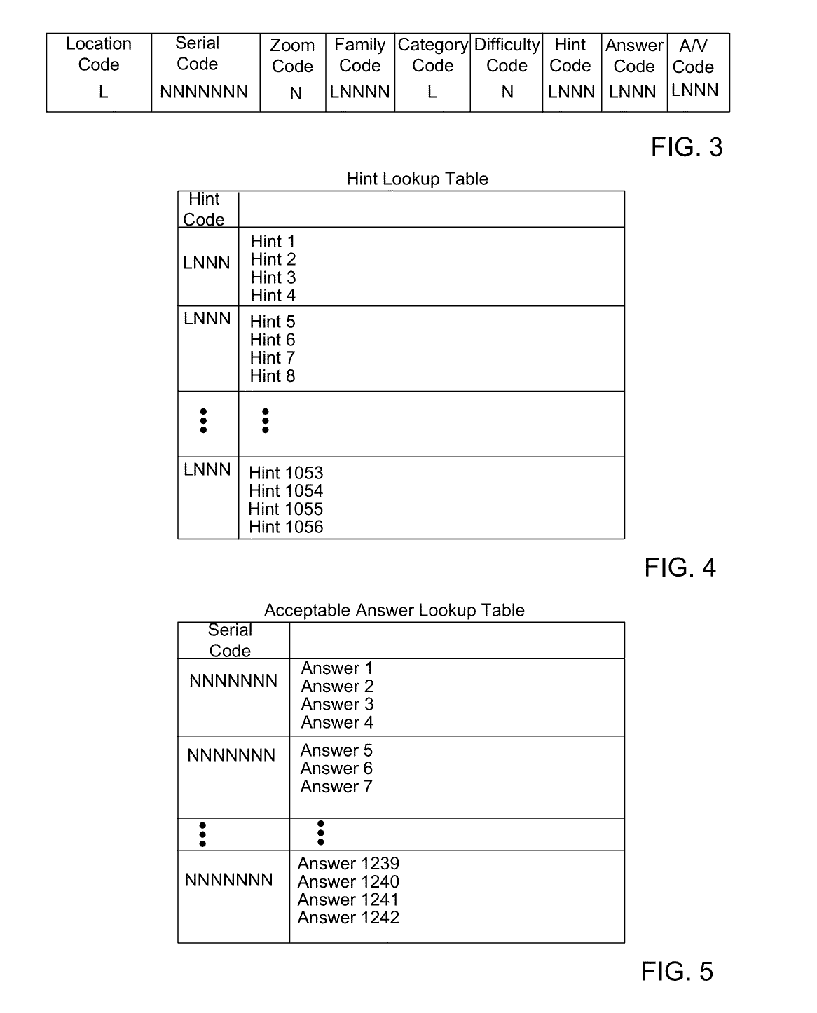

Turning now to FIG. 3, a diagram shows data fields of a name for a picture file according to an embodiment. In order to implement the various embodiments of enabling the display of an image associated with a picture file, as a part of an image identification game for example, a name associated with a given picture file provides information related to the content of the picture file, such as a location or a category of the image associated with the picture file. Accordingly, a picture file would have at least data associated with an image which is displayed and data which is used to uniquely identify the picture file (i.e. letters and/or numbers associated with a name).

According to the embodiment of FIG. 3, a field of the name will be designated by either a letter (L) or a number (N), or a combination of a letter or a number. The number of letters or numbers in a given field will depend upon the number of available data words which need to be represented by the field. For example, in a base 10 representation of the name, if less than 1000 possible data elements may be provided for a given field, three N bits would be required (i.e. 0-999).

In the case of letter fields, up to 26 letters may be used to provide a unique association with the picture file, as will be described in more detail below. Such a use of letter codes enable searching for a picture filed based a location or category associated with a given file, for example. That is, by providing a different letter for any given designation in a given field, all of the files associated with that letter designation can be identified.

As shown, in FIG. 3, the naming protocol includes a location field having an alphabetic location code, a numeric serial code, a numeric zoom code, an alphanumeric family code, an alphabetic category code, a numeric difficulty code, an alphanumeric hint code, an alphanumeric answer code, and an alphanumeric audio-visual (A/V). Although particular types of codes are shown, it should be understood that a greater number of codes, fewer codes, or different codes may be implemented, as will be described in more detail below.

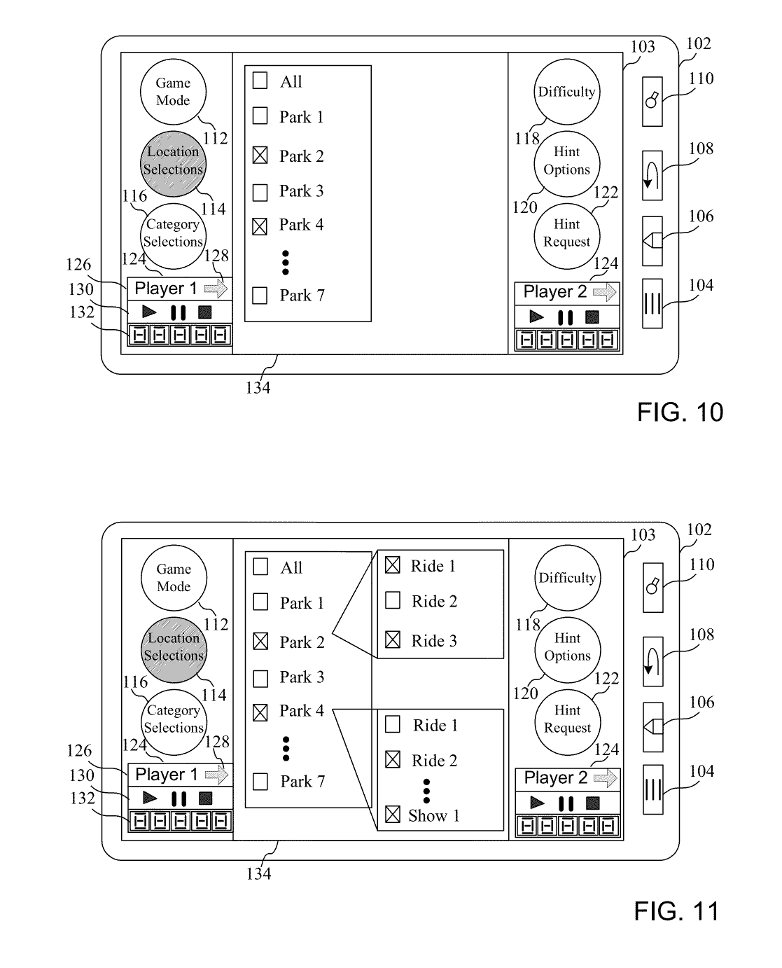

By providing a letter code identifying broad location associated with a picture file, a group of picture files associated with a common location can be created. As will be described in more detail below, applying a letter-based location code to a picture file enables the presentation of a plurality of picture files associated with a location for implementing a gaming application enabling the identification of a specific location associated with a picture file. The location code may represent a large area, such as a given theme park which is a part of a group of parks. For example, the location code may represent one of the parks of the Disney World group of parks. By using a unique letter code for each park (where that letter is not used in any other field), images associated with those picture files can be selectively applied if that park is selected as a part of an election option for displaying picture files. Alternatively, the locations could be different areas of a large university. That is, while various examples may be provided for one or more parks of a group of parks, it should be understood that the various embodiments could be implemented with different categories of picture files, such as different areas of a university (e.g. athletic buildings, academic buildings, certain sections of campus, etc.) or other large area, such as a city or a state. A numeric serial code is also provided in the name for the picture file to provide at least a unique identifying code for each picture file. The selection of location codes is described in more detail in reference to FIGS. 10 and 11.

Various codes may be provided which comprise relationship information. For example, a zoom code is one relationship field may be provided. As will be described in more detail below, certain picture identification games may show a series of images where the displayed image is zoomed out to a different zoom level. According to one embodiment, different picture files associated with a given location may comprise the same image, but having different zoom levels. Accordingly, a zoom code would be an extra bit at the end of the serial code which would distinguish different zoom levels of a common image. For example, the different zoom level of an image may be for the same image which is cropped differentially to show a different amount of a given location, making it increasingly easier to identify the location as the image is zoomed out. It should be noted that each picture file would still have a unique serial code when the zoom code is combined with the serial code. According to a different embodiment, a single image may be stored, where only a portion of that image is displayed for different zoom levels. That is, a zoom code would not be used, but multiple images may be sequentially displayed for a single picture file, where the multiple images comprise portions of the same image which are zoomed to a different zoom level.

According to one embodiment, another location code, designated a family code, could be provided as a part of a family of picture files. The family code may represent a sub-location representing different areas of the same location represented by the location code. The family code is a relationship field which indicates a relationship between different picture files. That is, multiple picture files (each having a unique serial code) may associated with a family of picture files. For example, while the location may be the Epcot theme park, a family of picture files could be associated with a particular attraction at the Epcot theme park, such as the Test Track ride. It should be noted that the picture files may be stored such that the correct answer for a given family may be narrower than the ride itself, and may be, for example, “the cooling chamber” of the GM test track. In this case, the serial code would be different, but multiple pictures having different serial codes may be associated with a family code. According to the embodiment of FIG. 3, the alphabetic portion of the code would be the same for the family code of all of the picture files, such as “F” for example, where a predetermined number of digits following the “F” would designate a unique family. As will be described in more detail below in reference to a particular image location identification game, multiple pictures of a given family would be provided in response to a hint request or as a part of a time-out to provide hints. Accordingly, a picture file may not have a zoom code, or that zoom code may be ignored when a particular game provides different picture files associated a family code.

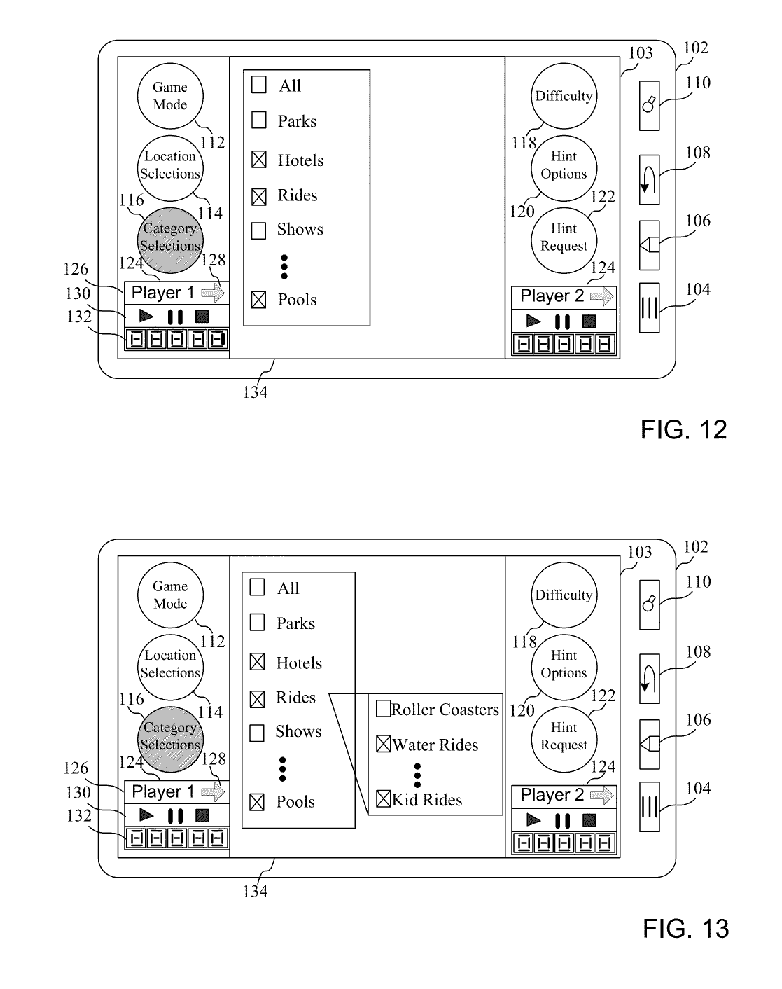

The picture file naming protocol of FIG. 3 may also use a category code, in conjunction with the family code, or separate from the family code. A category code could be similar to a location code, but rather than relating to a common physical location, the category code could relate to common subject matter of the image associated with the picture file. For example, in an application which relates to a group of theme parks (i.e. different locations identified by location codes), a category code may relate to a type of ride or attraction, where picture files having a common category code would be located in all of the different locations and possibly even sub-locations. For example, a category code may relate to particular type of ride such as “rollercoasters,” or even broader categories like “rides” or “shows.” While a single level of a category is disclosed in the category code, multiple levels of category code, such as category and sub-category (e.g. category of ride, and sub-category of rollercoaster) could be included in the picture file naming program. As will be described in more detail below, one game selection option may be to identify the specific locations of images associated with picture files having one or more category codes. Additional details related to the selection of categories are provided in more detail below in reference to FIGS. 12 and 13.

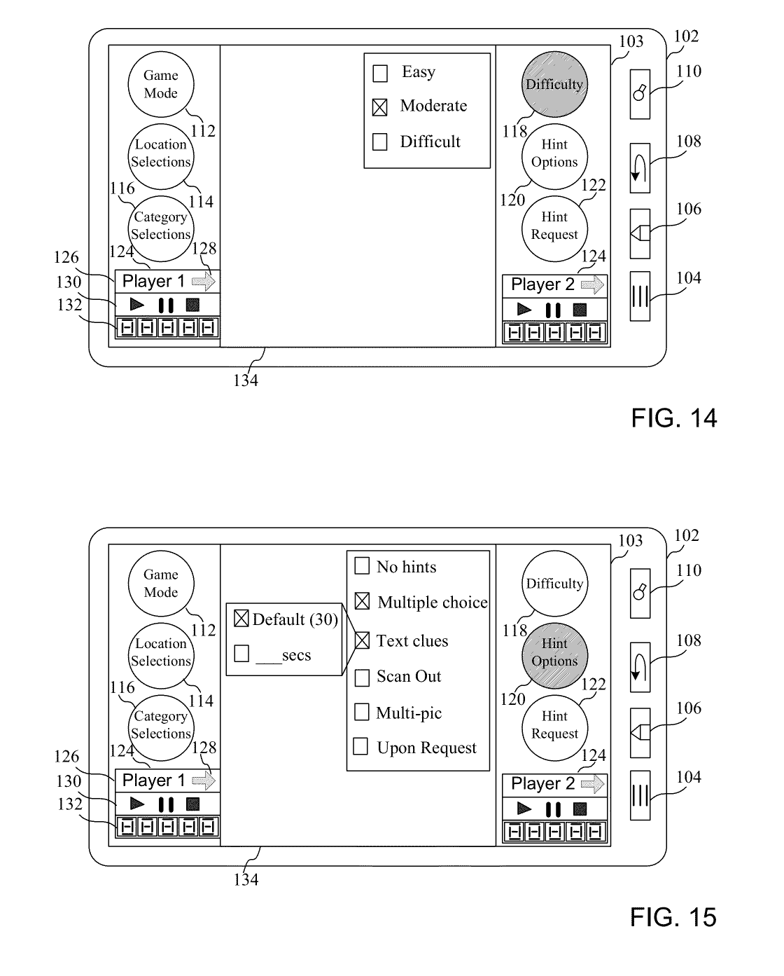

Other codes may also be included in the naming protocol. For example a difficulty code could be included. The difficulty code would enable images associated with certain picture files to be provided in a game for identifying locations of images in response to a user input. As will be described in more detail below in reference to FIG. 14, a difficulty code enables a user to select a difficulty of the images associated with a game.

Other codes provide links to tables to provide additional information or feedback to a user during a game. For example, a hint code is included to enable a hint to be provided in response to a request by a user or after a predetermined time, as will be set forth below. It should be noted that one or more specific hints could be provided for each individual picture file, in which case the serial code could be used as a link to a table storing the one or more hints associated with the location of the picture file. Alternatively, a hint code, such as the alpha numeric hint code shown by way of example in FIG. 3, provides a link to a hint table. It should be noted that one hint code could be used for a plurality of picture files, and therefore be used to provide hints for the plurality of picture files. Alternatively, an existing code identifying a plurality of picture files could be used as a hint code. For example, the family code could be used as the hint code. As shown in FIG. 4, a hint lookup table could be used when a hint is required. For example, when a hint is requested by a user or otherwise provided during a game for identifying the location of an image, a hint associated with the hint code will be provided on the display. If more than one hint is required, additional hints associated with the one hint code, if available, will be subsequently provided. Although 4 hints are shown, any number of hints could be provided for each code in the hint lookup table. Additional details related to the use of hints in an image identification game are provided in reference to FIG. 15

Further, an answer code could be included in the picture file naming protocol. After an answer is provided by a user, the answer is compared by a processor, or other control circuit of the device enabling a comparison, of the device to answers provided with the corresponding answer code in an “acceptable answer” lookup table, such as the acceptable answer lookup table as shown in FIG. 5. The acceptable answers provide the specific location of an image. While a single correct answer may be required to receive credit for a correct answer, the various answers provided in the table may include a number of entries, where portions of a correct answer may be provided. Accordingly, a user may be credited with entering a correct answer if even a portion of the answer provided by the user matches a term or phrase provided as an acceptable answer. Alternatively, a user may be credited with entering a correct answer if the answer matches even a portion of an answer in the answer table. While the table of FIG. 5 shows acceptable answers associated with a serial code of a particular picture file, a group of answers could also be provided with a corresponding family code, for example.

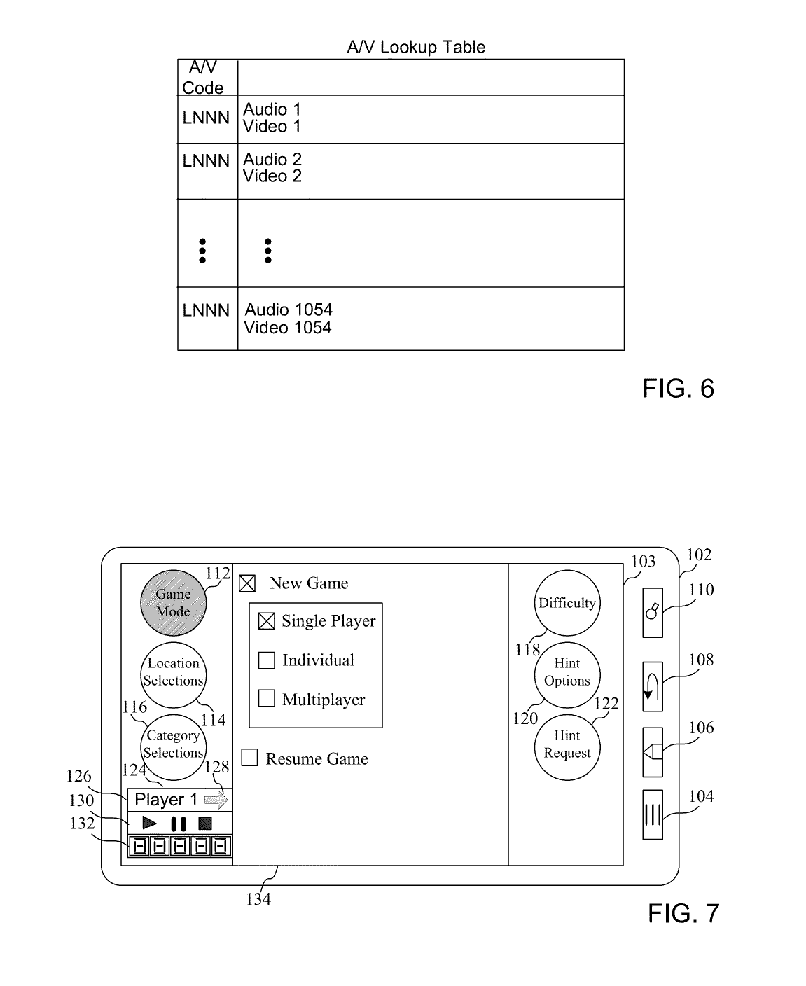

Finally, an audio/visual (A/V) code provides a link to an audio and or visual file which may be displayed when a user correctly enters an answer associated with a picture file. For example, if a user enters the correct answer on a display, an indication of a correct answer, such simulated fireworks, may be displayed across the screen. Alternatively, the visual image displayed in response to the correct answer may be associated with the location of the image. For example, if the location of the picture file is the Toy Story Mania attraction at the Hollywood Studios theme park, the visual image provided in response to the correct answer could be specifically associated with the Toy Story Mania attraction, such as paint ball patterns, rubber darts, or other images commonly used in the game. Similarly, an audio file could be played in response to a correct answer, alone or in combination with the visual image. The audio file could be generic (e.g. an audio response such as “You're right!”) or specific to an attraction at a particular theme park. As shown in the A/V lookup table of FIG. 6, an audio file and a video file is shown with each A/V code. While both an audio and a video file are shown in FIG. 6, it should be understood that either the audio or visual file could be provided. Further, an audio and/or visual file could be provided for each picture file, or could be associated with some other field (other than the A/V code as shown). For example, the A/V lookup table could provide audio and/or visual files associated with a family code, for example.

According to the various embodiments of FIGS. 7-19 which are now described, a particular selection option which is currently accessed by a user is shown shaded to indicate that the user is selecting various features related to the selection option. The selections of the various features could be by touch screen actuation, for example. Turning first to FIG. 7, a top plan view of a portable wireless device shows a game selection mode for an individual player and available options and sub-options according to an embodiment of the present invention. According to the embodiment of FIG. 7, game mode selection actuator 112, when selected, enables a user to select different game mode features. A user may have an option for selecting a new game or resuming a current game. One option available to a user is whether an individual player will be playing, or a single player or multiple players will be playing. One difference between an individual player and a single player is that an individual player is a “known player” associated with the wireless device (i.e. a player who has already provided some information identifying the player, such as initials), compared to a single player that is a random player who just happens to be using the wireless device and who may not be using the device again, or may not want any type of data associated with the game to be stored for the player. For multiple players, either individual users who sign in or single players could play. The selection of a single player is shown in FIG. 7. Accordingly, only a single player control panel is shown, where the player is designated as Player 1.

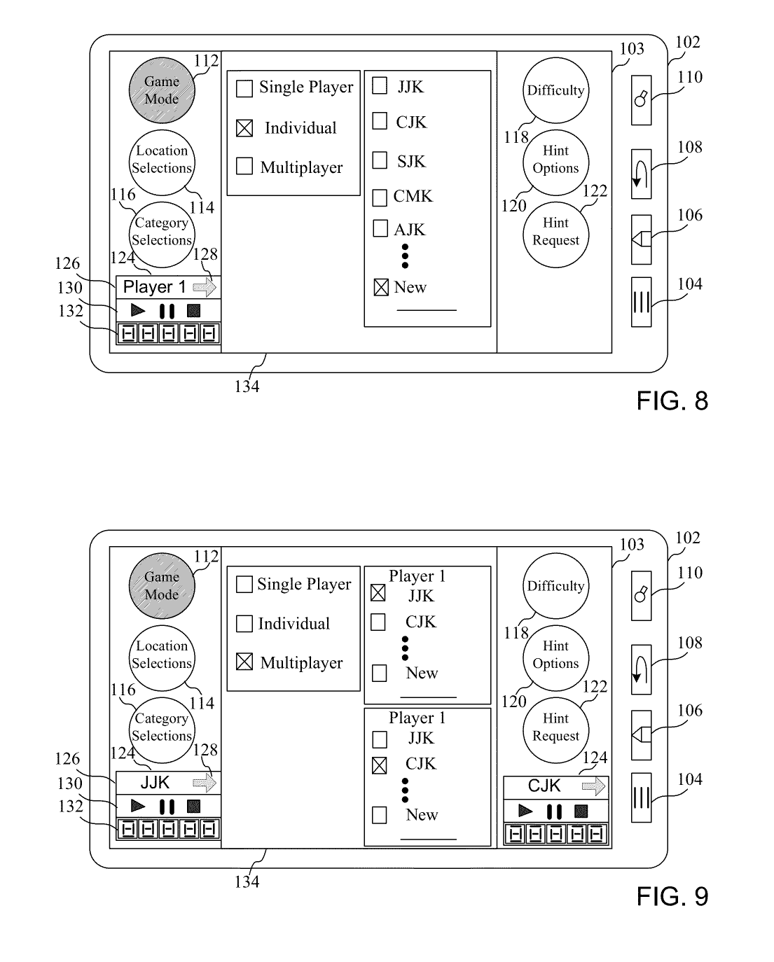

As shown in FIG. 8, when the actuator for “Individual Player” is selected, a list of individual players which have already been entered in the device is provided, as well as an option to enter a new user, where the new player's initials would be entered. As can be seen, the selected user's initials are provided in the scoreboard in place of “Player 1.” In FIG. 9, a multiplayer option is selected. Accordingly, the initials of the individual players are provided along with an option for entering a new player, as described above in reference to FIG. 8. If individual players are selected, the initials of the individual players are provided in the respective player control panels. While two players are shown by way of example, it should be understood that other numbers of players could play in an image identification game according to the various embodiments.

Turning now to FIG. 10, a top plan view of a portable wireless device shows a location selection according to an embodiment of the present invention. According to the embodiment of FIG. 10, images associated with selected locations will be displayed during a game to identify the location of picture files. As shown in FIG. 10, two parks of a group of available theme parks are selected. According to the embodiment of FIG. 11, sub-categories for selected parks can be selected. For example, certain rides may be selected for Park 2, while a ride and a show are selected for Park 4.

Turning now to FIG. 12, a top plan view of a portable wireless device showing a category selection according to an embodiment of the present invention is shown. Rather than selecting locations, such as particular parks of a group of theme parks, category selections can be made. As shown in FIG. 12, images associated with categories of images, such as hotels, rides and pools, can be selected to be displayed in a game for identifying images. Sub-categories can also be selected for a given category, as shown in FIG. 13 where sub-categories for rides (i.e. water rides and kid rides) is selected, for example. It should be noted that categories can be selected in addition to locations, or without any selection of locations.

Turning now to FIG. 14, a top plan view of a portable wireless device showing a difficulty selection according to an embodiment of the present invention is shown. As shown in FIG. 14, a user may select one of a plurality of difficulty levels, for example.

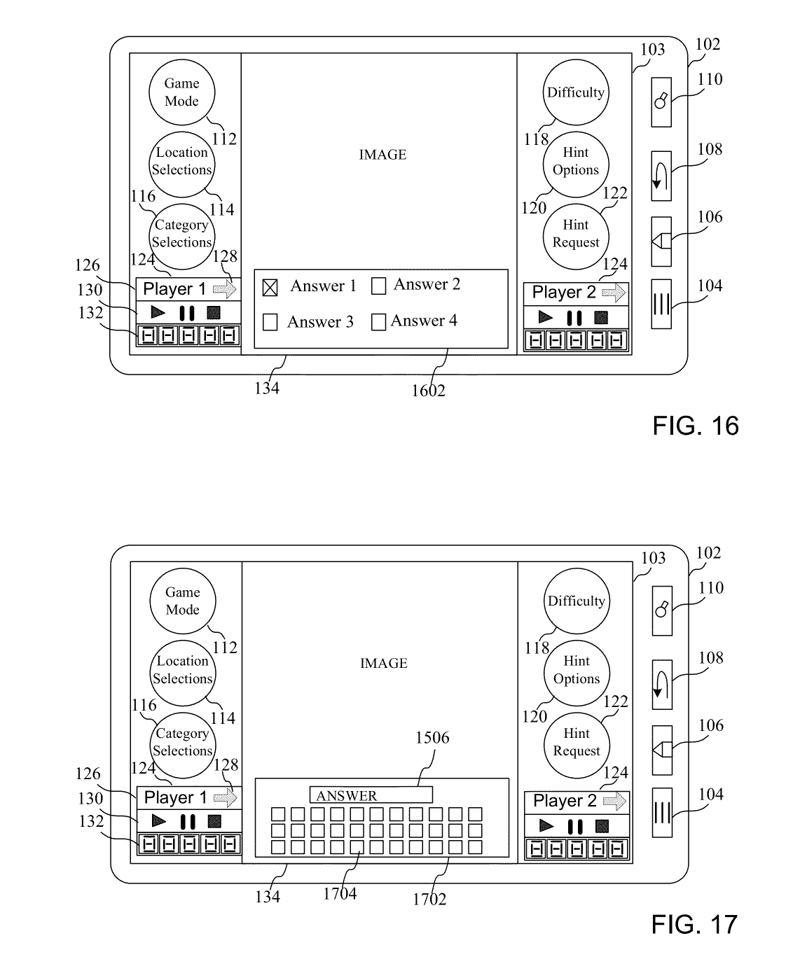

Turning now to FIG. 15, a top plan view of a portable wireless device showing hint option and sub-option selections according to an embodiment is shown. As shown in FIG. 15, various options can be selected by the user. For example, a user can select to have no hints provided during a game for identifying an image. An option for providing multiple choice answers which may be selected by a user is provided, as will be described in more detail below in reference to FIG. 16. A user selection option for text clues is provided, where the user can select a default of providing a text clue after 30 seconds or after a user selectable number of seconds after the image in displayed on the screen. According to another embodiment, rather than providing text clues, or in addition to providing text clues, a user could select an option of “scanning out” for a given image. The scanning out could be for a given picture file, where the portable wireless device would enable displaying a larger version of a given picture file which was “cropped.” That is, a larger portion of the image may be displayed according to one of the embodiments set forth above, making it easier to identify the location of the image. A user may select that hints are provided upon request, where a user may select hints by selecting the hint request actuator 122. Alternatively, a user could select a hint using the actuator without the “upon request” option be selected. That is, hints could be provided upon request in response to the selection of the hint request actuator by default, where the user may opt to disable the hint request actuator.

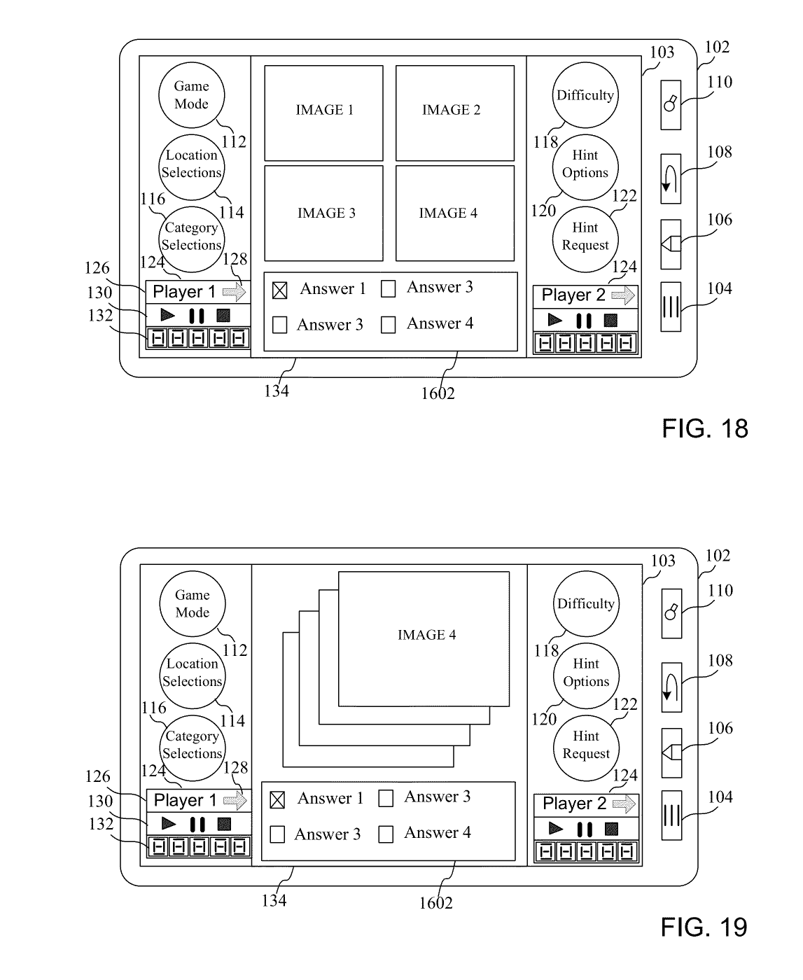

According to a different embodiment, a multi-picture option can be selected by a user. According to a multi-picture embodiment, a different picture file having an image related to the location of an earlier picture file displayed. As shown by way of example in FIG. 18, 4 images for different picture files associated with a given location are provided on the display. The images may be provided according to a selectable delay similar to the delays for text hints. Hints (such as text hints or additional images in a multi-picture mode) could be provided upon request, such as in response to a hint request actuator 122, or in response to an audible request for a hint.

Turning now to FIG. 16, a top plan view of a portable wireless device shows an interface enabling a multiple choice answer selection according to an embodiment of the present invention. As shown in FIG. 16, 4 answers are provided, where a given answer can be selected by a user (shown here as answer 1). Alternatively, as shown in FIG. 17, an answer can be entered by a user. For example, a touch screen keypad 1702 having keys 1704 enables a user to enter an answer in an answer box 1506. According to other embodiments, the answer may be entered by a keypad on the device or attached to the device.

According to the embodiment of FIG. 18, multiple images can be selectively and sequentially displayed in response to hints, as described above. Accordingly, an additional image will be provided with each hint until a predetermined number of images are shown, which is 4 according to the embodiment of FIG. 18. As shown in FIG. 18, the answer options are provided by multiple choice answers, however a user could enter the answer on a keypad according to another embodiment, as described above in FIG. 17 or by way of an external keypad coupled to the device. The embodiment of FIG. 18 finds particular application in an embodiment which shows different images, rather than different zoom levels of a given image.

Turning now to FIG. 19, a top plan view of a portable wireless device shows a plurality of images associated with a particular location which may be identified by a multiple choice answer selection according to an alternate embodiment. Because the embodiment of FIG. 19 displays multiple images which are sequentially covered, a larger version of the image can be displayed. That is, the embodiment of FIG. 19 finds particular application with an embodiment which shows different levels of zoom of a given image, where displaying the different levels of a given image as shown in FIG. 18 would not be of much additional assistance when different zoom levels are provided in each of the images. Further, the embodiment of FIG. 19 enables the most recently displayed image to be displayed in a larger dimension compared to the embodiment of FIG. 18.

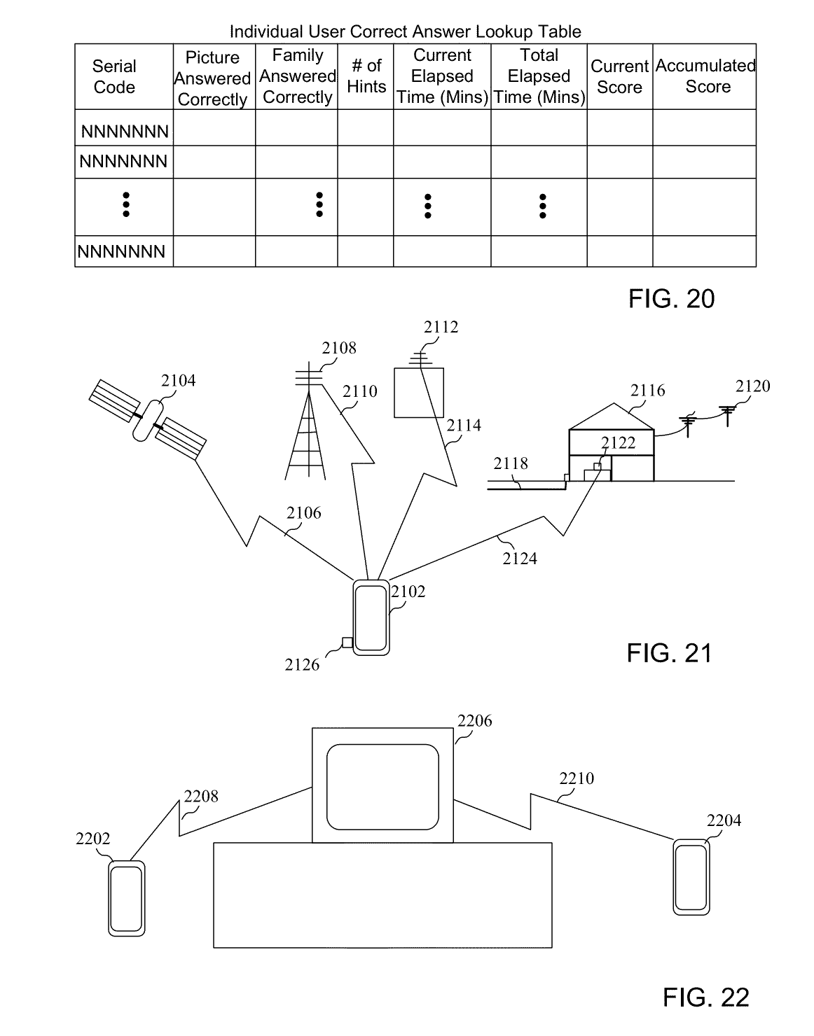

Turning now to FIG. 20, a correct answer table for an individual user according to an embodiment of the present invention is shown. The correct answer table is used to store data related to the individual user's answers. The data may include not only data related to a current game in which the individual user is participating, but also cumulative data for an individual user. That is, the cumulative data not only prevents picture files which the user had already correctly answered from being presented to the user, but also provide accumulated score data. More particularly, for each individual picture file, the correct answer table can be used to record the picture files for which a correct answer has been given. The table may also indicate which families of picture files have a certain picture file which the user answered correctly. That is, if a user correctly identifies the location for a picture file of a family of picture files, it may be desirable to not display images associated with other picture files of the family to make the game more interesting and challenging. Alternatively, picture files of families having a picture file which had been correctly identified may be displayed after all of the picture files (which are not in a family of an identified picture file) are displayed. Further, any picture file which had not been displayed as a part of a hint may be displayed before a picture file which had been displayed associated with a hint.

Data for determining a current and total score may also be maintained in the table. For example, a number of hints required to correctly identify the location of an image may be included. Also, an elapsed time to identify the location of a given picture file may be included in the table. A score for identifying that given picture file may be generated based upon the number of hints and the elapsed time required to identify the image. For example, the score associated with a given picture file would be greater for a user requiring fewer hints and having a lower elapsed time to identify the image. A formula and weighting values for an equation utilizing the number of hints and elapsed time may be generated based upon empirical testing, where the values may depend upon the difficulty of the hints, for example. Although two factors, namely hints and elapsed time are included, other factors could be included in determining a score. Finally, a total elapsed time can be included, where a total score could be calculated based upon the scores for the individual picture files and the total elapsed time. Alternatively, the total elapsed time could be displayed for information for the user. The data for the table could be stored on the portable wireless device, or on a server as will be described in more detail below.

Turning now to FIG. 21, a block diagram of elements of a system enabling communication with the portable wireless device according to an embodiment of the present invention is shown. A portable wireless device 2102 may be coupled to one or more of a plurality of communication networks which enables a user to access a program enabling the identification of images as well as the picture file data and any lookup tables, as set forth above. The program and data may be downloaded from a satellite network 2104 by way of a wireless communications link 2106, a cellular communications network 2108 by way of a wireless communication link 2110, a local area network 2112, such as a WiFi network, by way of a wireless communication link 2114. The program and data may also be provided from a user's home 2116 received by way of a cable television link 2118 or telephone network 2120 at a computer 2122 and coupled to the portable wireless device by way of a communication link 2124, which could be a wired link or wireless link. While examples of various communication networks are shown, it should be understood that other wireless or wired communication networks could be used. Alternatively, the programs and data could be transferred by a portable memory device 2126, such as a USB drive or SD memory card, directly to the portable wireless device. The program and data could be transferred from the portable memory or could reside on the portable memory which functions as a “game cartridge” as implemented in many conventional gaming programs.

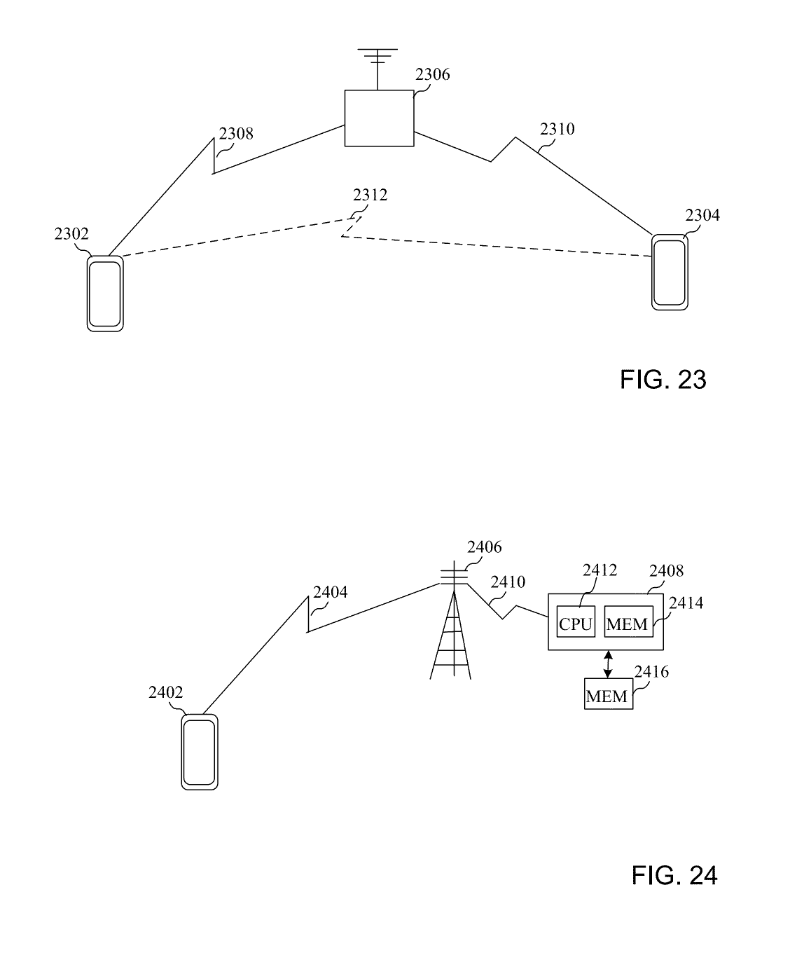

Turning now to FIGS. 22 and 23, block diagrams show different operating environments for playing a game of identifying images with multiple players. In FIG. 22, a block diagram of a system having a monitor enabling gaming with two portable wireless devices according to an embodiment of the present invention is shown. Multiple portable wireless devices, shown here as portable wireless devices 2202 and 2204 are in communication with a monitor 2206 by way of communication links 2208 and 2210, respectively. The communication links may be wired or wireless links, such as an infrared (IR) link, Bluetooth link, or some other low-power, short range, wireless connection link. While two portable wireless devices are shown, more than two could be employed according to various embodiments.

According to the embodiment of FIG. 23, multiple portable wireless devices can play in the same image identification game by way of a communication link. That is, rather than displaying the game on a single display, such as a single portable wireless device or the display 2206 which is remote from the portable wireless devices, the game is displayed on each portable wireless device. That is, the same game played by multiple players is displayed in each portable wireless device. According to the embodiment of FIG. 23, each of the portable wireless devices 2302 and 2304 are coupled to a wireless communication network 2306, such as a WiFi network, by way of communication links 2308 and 2310, respectively. Alternatively, the portable wireless devices 2304 and 2308 may be coupled to communicate directly with each other by way of a wired or wireless communication link 2312, such as an infrared (IR) link, Bluetooth link, or some other low-power, short range, wireless connection link.

Turning now to FIG. 24, a block diagram of a wireless communication network having a remote computer communicating with a wireless communication device according to an embodiment of the present invention is shown. According to the embodiment of FIG. 24, a portable wireless device 2402 is coupled by a wireless communication link 2404 to a communication network 2406 which enables access to a remote computer 2408 by way of a communication link 2410. The remote computer has a central processing unit (CPU) 2412 coupled to an internal memory 2414 and optionally an external memory 2416. The remote computer could be any type of computer for communicating the program, picture file and table data as set forth above, and processing and storing results for individual users. The computer could be a computer server available from Hewlett-Packard Company of Palo Alto, Calif., for example. The computer could enable the transfer of the computer program having the picture identification game, or any data required for the game. If a portable wireless device does not have enough memory to store all of the picture files, the computer could enable downloading some of the picture files and associated data (e.g. a certain number of picture files or a predetermined data size), and updating the picture files when necessary as set forth below. The computer could also serve to receive photos when new photos for the picture identification game are available, and to provide the picture files to a portable wireless device.

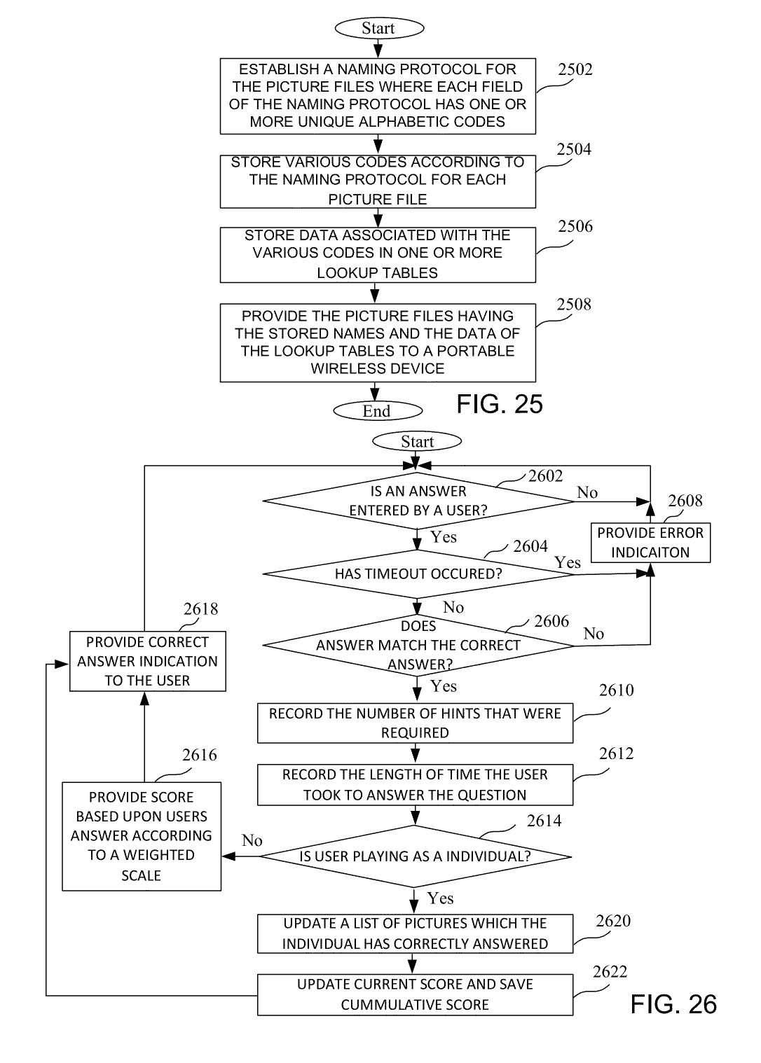

A plurality of flow charts is shown according to various methods of displaying images on a portable wireless device or on a display. The methods may be implemented using the devices and systems of FIGS. 1-24 as described, or other suitable devices and systems. Although various steps of the methods are shown, it should be understood that additional steps could be performed as described in the embodiments of FIGS. 1-24. Turning first to FIG. 25, a flow chart shows a method of storing data associated with picture files according to an embodiment of the present invention. In particular, a naming protocol for the picture files is established at a step 2502, where each field of the naming protocol has one or more alphabetic codes. Various codes are stored in the picture name for each picture file of a plurality of picture files at a step 2504. Data associated with the various codes stored at the step 2504 is stored in lookup tables. Such as the lookup tables of FIGS. 4-6, at a step 2506. The picture files having the stored names and the data of the lookup table is provided to the wireless communication device at a step 2508.

Turning now to FIG. 26, a flow chart shows a method of enabling a game associated with picture files according to an embodiment of the present invention. In particular, it is first determined whether an answer is entered by a user at a step 2602. If so, it is then determined whether a timeout has occurred at a step 2604. If a timeout has occurred or an answer does not match a correct answer at a step 2606, an error indication is provided at a step 2608. If an answer does match a correct answer, the number of hints required by a user to identify an image is recorded at a step 2610, and the length of time the user took to identify an image at a step 2612. It is then determined whether the user is playing as an individual at a step 2614. If not, a score based upon a user's answers according to a weighted scale is provided at a step 2616, and a correct answer indication is provided to the user at the step 2618. If the user is playing as an individual user, a list of pictures which the individual has correctly answered is updated, such as described above in reference to FIG. 20, at a step 2620. An individual current score and a cumulative score are updated and saved at a step 2822. After a correct answer indication or an error indication is provided, the device implementing the method waits until another answer is entered by the user after a new image is provided.

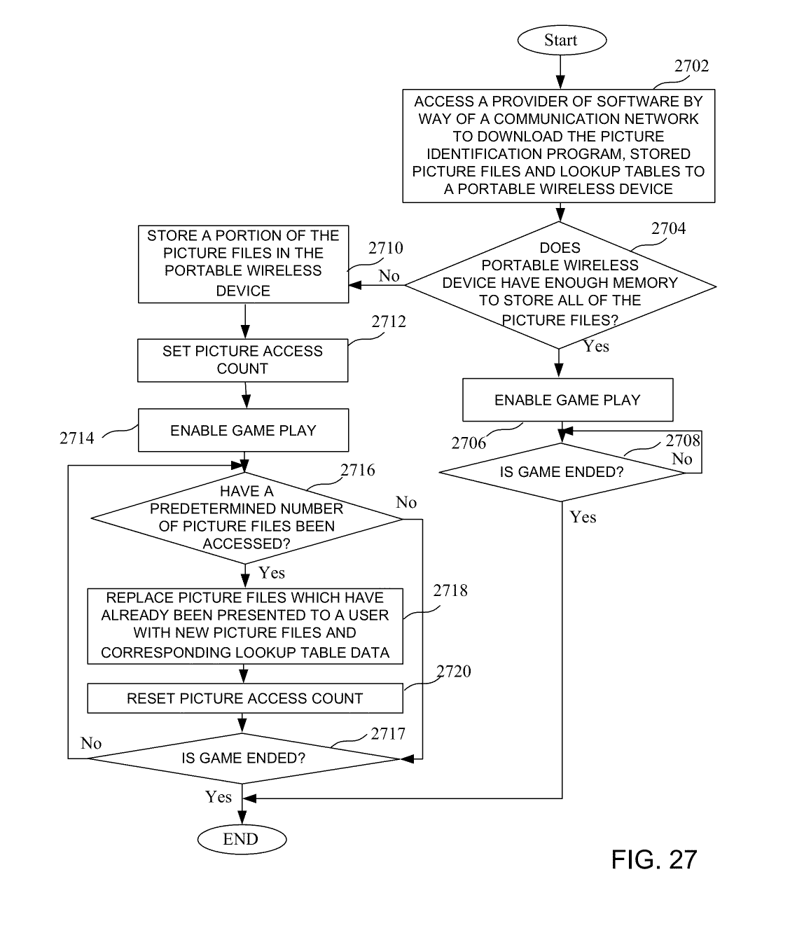

Turning now to FIG. 27, a flow chart shows a method of enabling the downloading the picture files to a portable wireless device according to an embodiment of the present invention. According to the embodiment of FIG. 27, a provider of software is accessed by way of a communication network to download the picture program, stored pictures and lookup tables to a portable wireless device at a step 2702. It is then determined whether a portable wireless device has enough memory to store all of the picture files at a step 2704. If so, all of the picture files and lookup tables are stored and a game is enabled at a step 2706. Until it is determined that the game is ended at a step 2708, game play continues.

If the portable wireless device does not have enough memory to store all of the picture files, a portion of the picture files are stored at a step 2710, a picture access count is set at a step 2712, and the game play is enabled at a step 2714. It is then determined whether a predetermined number of picture files been accessed at a step 2716. If not, the game is continued, and it is determined whether the game has ended at a step 2717. If the predetermined number of picture files have been accessed, picture files which have already been presented to a user are replaced with new picture files at a step 2718, and the picture access count is reset at a step 2720. The game play will continue until the game is ended.

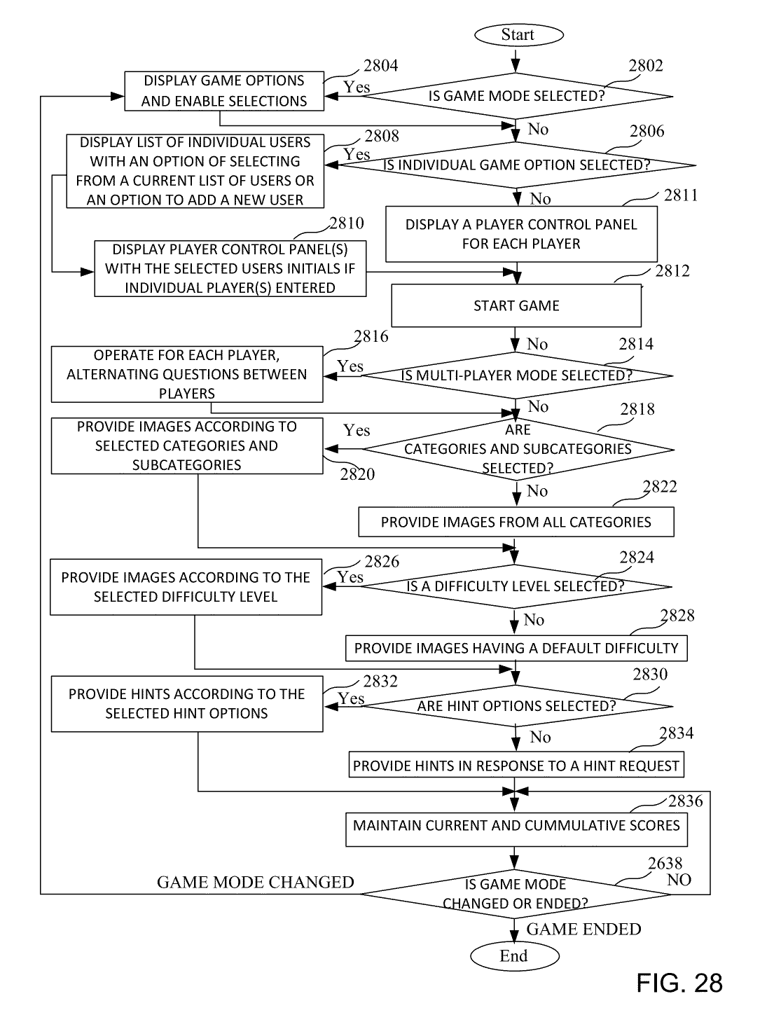

Turning now to FIG. 28, a flow chart shows the operation of a user interface according to an embodiment of the present invention. It is first determined whether a game mode selected at a step 2802. If so, game options are displayed and selections enabled at a step 2804. It is then determined whether an individual game option selected at a step 2806. If so, a list of individual users is displayed with an option of selecting one of a current users or an option to add a new individual user at a step 2808. One or more player control panels are displayed with initials if individual users are selected at a step 2810. Otherwise, a player control panel is displayed for each player at a step 2811, and the game is started at a step 2812.

It is then determined whether a multi-player mode is selected at a step 2814. If so, the game is started for each player, with questions being presented sequentially to each player at a step 2816. It is then determined whether categories and subcategories are selected at a step 2818. If so, images are provided according to selected categories and sub-categories at a step 2820. If not, images are provided from all categories at a step 2822. It is then determined whether a difficulty level is selected at a step 2824. If so, images are provided according to selected difficulty level at a step 2826. If not, images are provided from all difficulty levels at a step 2828. It is then determined whether hint options are selected at a step 2830. If so, hints are provided according to selected hint options at a step 2832. If not, hints are only provided in response to a hint request at a step 2834. Current and accumulated scores are maintained in response to user answers at a step 2836. It is then determined whether a game mode is changed or ended at a step 2836. If the user requests a game mode change, the game mode options are again displayed at the step 2804. If the game is not ended, the device continues to maintain current and accumulated scores at the step 2836 in response to user answers identifying the locations of images associated with picture files (until the game is ended.

It can therefore be appreciated that the new and novel portable wireless device and method of displaying a plurality of picture files has been described. It will be appreciated by those skilled in the art that numerous alternatives and equivalents will be seen to exist which incorporate the disclosed invention. As a result, the invention is not to be limited by the foregoing embodiments, but only by the following claims.

I claim:

1. A method of displaying images associated with a plurality of picture files on a display of a portable wireless device, the method comprising:
displaying a first image associated with a first picture file;
enabling a user to identify a location associated with the first picture file; and
displaying a second image in response to a prompt for a next picture file;
wherein the second image is related to the first image.

2. The method of claim 1 wherein the second image is a zoomed-out version of the first image.

3. The method of claim 1 wherein the second image is associated with a second picture file.

4. The method of claim 3 wherein the second picture file is zoomed-out image of the first picture file.

5. The method of claim 1 wherein the first picture file and the second picture file are associated with a first location.

6. The method of claim 1 wherein the prompt is provided by a user.

7. The method of claim 1 wherein the prompt is provided in response to a time-out.

8. A method of displaying images associated with a plurality of picture files on a display of a portable wireless device, the method comprising:
displaying a first image associated with first picture file;
receiving a request for a hint by a user; and
displaying a second image in response to the request for a hint;
wherein the second image is related to the first image.

9. The method of claim 8 wherein the second image is a zoomed-out version of the first image.

10. The method of claim 8 wherein the second image is associated with a second picture file.

11. The method of claim 10 wherein the second picture file is zoomed-out image of the first picture file.

12. The method of claim 8 wherein the first picture file and the second picture file are associated with a first location.

13. The method of claim 8 further comprising enabling the user to identify the location of the picture file.

14. The method of claim 13 wherein enabling the user to identify the location of the picture file comprises enabling the user to select a location of a plurality of locations, provided on the display, which might be associated with the picture file.

15. A portable wireless device enabling the display of an image, the portable wireless device comprising:
a memory storing a plurality of picture files;
a control circuit coupled to the memory, the control circuit enabling the display of a first image associated with a first picture file of the plurality of picture files; and
a display enabling a user to identify a location associated with the first picture file,
wherein a second image is displayed in response to a prompt for a new image.

16. The portable wireless device of claim 15 wherein the second image is a zoomed-out version of the first image.

17. The portable wireless device of claim 15 wherein the second image is associated with a second picture file, and the second picture file is zoomed-out image of the first picture file.

18. The portable wireless device of claim 15 wherein the first picture file and the second picture file are associated with a first location.

19. The portable wireless device of claim 15 wherein the prompt is provided by a user.

20. The portable wireless device of claim 15 wherein the prompt is provided in response to a time-out.
